(19) United States
(12) Patent Application Publication
(10) Pub. No.: US 2011/0279454 A1
(43) Pub. Date: Nov. 17, 2011

(54) THREE-DIMENSIONAL DISPLAY AND THREE-DIMENSIONAL DISPLAY SYSTEM

(75) Inventor: Jih-Fon Huang, Hsinchu County (TW)

(73) Assignee: INDUSTRIAL TECHNOLOGY RESEARCH INSTITUTE, Hsinchu (TW)

(21) Appl. No.: 12/853,306

(22) Filed: Aug. 10, 2010

(30) Foreign Application Priority Data
May 14, 2010 (TW) 99115502

(51) Int. Cl. G06T 15/50; G09G 5/10

(52) U.S. Cl. 345/426; 345/690

(57) ABSTRACT

A three-dimensional display includes a first display module, a second display module, a light-combining module and a view-scanning layer. The first display module provides a first display image. The second display module provides a second display image. The light-combining module is disposed in a first transmission path of the first display image and a second transmission path of the second display image. The first transmission path and the second transmission path after the first light-combining module have the same direction. The view-scanning layer receives the first display image transmitted along the first transmission path and the second display image transmitted along the second transmission path and respectively projects a part of the first display image and a part of the second display image onto a first view direction and a second view direction.

### CROSS-REFERENCE TO RELATED APPLICATION

This application claims the priority benefit of Taiwan application serial no. 99115502, filed on May 14, 2010. The entirety of the above-mentioned patent application is hereby incorporated by reference herein and made a part of this specification.

### TECHNICAL FIELD

The disclosure relates to a display and a display system, and more particularly, to a three-dimensional display and a three-dimensional display system.

### BACKGROUND

The three-dimensional display technology can be categorized into stereoscopic type and auto-stereoscopic type according to the usage. With an auto-stereoscopic three-dimensional display, the user has no need to wear glasses or a helmet to see vivid three-dimensional images. Therefore, in comparison with a stereoscopic three-dimensional display, the auto-stereoscopic three-dimensional display is better to meet the requirement of human on natural vision.

However, to increase the number of views, the auto-stereoscopic three-dimensional display must sacrifice its horizontal resolution and vertical resolution (X resolution and Y resolution) so that the auto-stereoscopic three-dimensional display is hard to meet both the requirements of resolution and number of views. As a result, the auto-stereoscopic three-dimensional display can not compete against the planar display in terms of resolution and number of views, which is also one of the reasons for the three-dimensional technology to fail gaining popular applications. And, the stereoscopic three-dimensional display thereby plays the major role in the three-dimensional display market.

On the other hand, several related three-dimensional technologies or three-dimensional displays have been provided in the last years. U.S. Pat. No. 5,969,850 discloses a 2D/3D switchable display mainly by using two liquid crystal layers stacked by each other to realize 2D/3D display mode.

Another technology, so-called “iScreene high display quality three-dimensional display technology” employs a plurality of projectors in an array and adopts image collective projections so as to divide a frame into a plurality of parts and to project the parts so as to obtain a better angle of view and display quality, wherein the resolution of a three-dimensional image is increased with increasing the quantity of the projectors.

In addition, U.S. Pat. No. 7,489,445 B2 discloses a display, which utilizes a detachable parallax barrier film to realize a planar display mode or a three-dimensional display mode. U.S. Pat. No. 6,064,424 discloses a three-dimensional display which includes a slanted lenticular element, wherein the slanted lenticular element is disposed on a plurality of pixels so that the light passing through the pixels deflects to different directions and the left eye and the right eye of a viewer can see different images, which makes the viewer sense a three-dimensional image in the brain thereof.

### SUMMARY

A three-dimensional display is introduced herein which is able to provide display images along a plurality of view directions according to an exemplary embodiment of the disclosure.

A three-dimensional display system is introduced herein which is able to provide display images along a plurality of view directions according to an exemplary embodiment of the disclosure.

An exemplary embodiment of the disclosure provides a three-dimensional display, which includes a first display module, a second display module, a first light-combining module and a view-scanning layer. The first display module provides a first display image. The second display module provides a second display image. The first light-combining module is disposed in a first transmission path of the first display image and a second transmission path of the second display image. The first transmission path and the second transmission path after the first light-combining module have the same direction. The view-scanning layer receives the first display image transmitted along the first transmission path and the second display image transmitted along the second transmission path and respectively projects a part of the first display image and a part of the second display image onto a first view direction and a second view direction.

An exemplary embodiment of the disclosure also provides a three-dimensional display system, which includes a processing unit, at least one display module and a view-scanning module. The processing unit outputs a plurality of video data, a plurality of control signals and a scan signal. The display module is coupled to the processing unit and respectively receives the video data and the control signals. The display module provides a display image according to the corresponding video data and control signal. The view-scanning module is coupled to the processing unit and receives the scan signal. The view-scanning module projects a part of the display image passing through the view-scanning module onto one of a plurality of view directions according to the scan signal.

Based on the depiction above, the three-dimensional display and the three-dimensional display system of the disclosure mainly utilize the view-scanning layer and the view-scanning module respectively to project different display images at different time onto a plurality of view directions and in association with at least two display modules to alternately provide the display images so as to reach the wide view angle and reduce an image cross-talk.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a schematic diagram illustrating a three-dimensional display 100 according to the first exemplary embodiment of the present disclosure.

FIG. 2 is a localized enlarged diagram of the region A in the three-dimensional display 100 of FIG. 1.

FIG. 3A is a schematic diagram showing an arrangement of the LC molecules without applying an external electric field of the region C of FIG. 2.

FIG. 3B is a schematic diagram showing an arrangement of the LC molecules after applying an external electric field on the LC molecules of the region C of FIG. 2.

FIG. 4 is a schematic diagram illustrating a three-dimensional display 200 according to the second exemplary embodiment of the present disclosure.

FIG. 5A is a schematic diagram illustrating a three-dimensional display 300a according to the third exemplary embodiment of the present disclosure.

FIG. 5B is a schematic diagram illustrating a three-dimensional display 300b according to another exemplary embodiment of the present disclosure.

FIG. 6 is a schematic diagram illustrating a three-dimensional display 400 according to the forth exemplary embodiment of the present disclosure.

FIG. 7A is a block diagram of a three-dimensional display system according to the fifth exemplary embodiment of the present disclosure.

FIG. 7B is a block diagram of a three-dimensional display system according to the sixth exemplary embodiment of the present disclosure.

FIG. 8 is a timing diagram of the three-dimensional display system of FIG. 7A.

### DETAILED DESCRIPTION OF DISCLOSED EMBODIMENTS

### The First Exemplary Embodiment

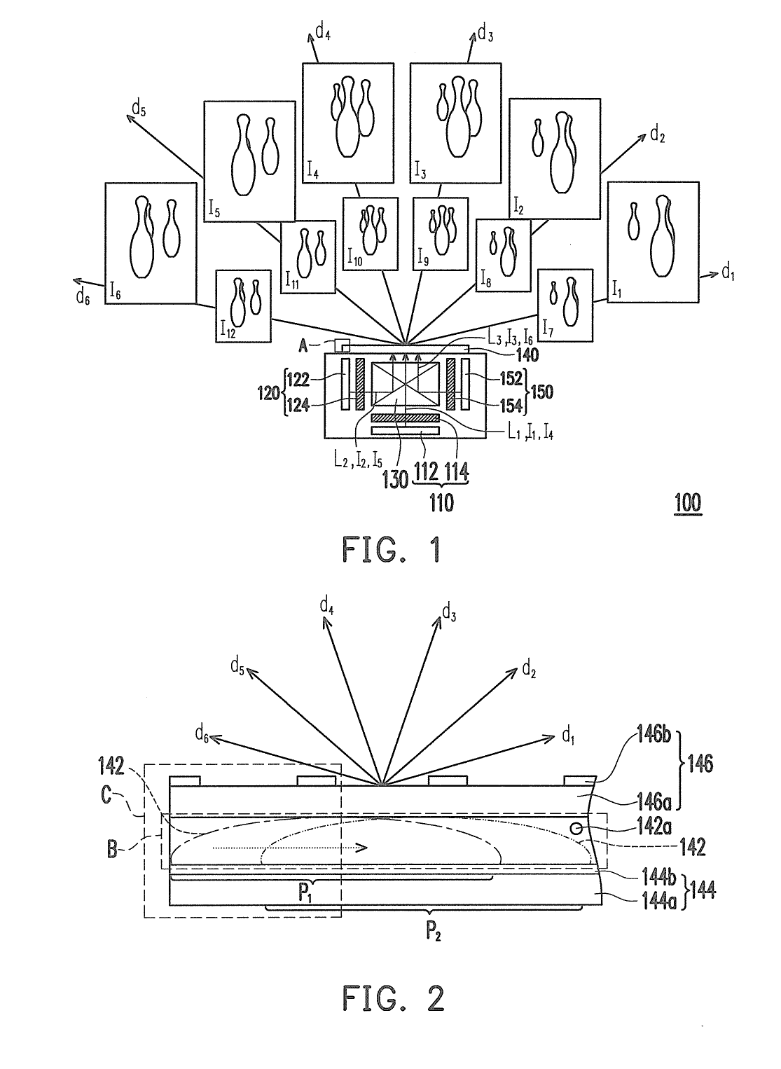

FIG. 1 is a diagram illustrating a three-dimensional display 100 according to the first exemplary embodiment of the present disclosure. Referring to FIG. 1, a three-dimensional (3D) display 100 includes two display modules 110 and 120, a light-combining module 130 and a view-scanning layer 140. The display module 110 provides a display image I₁, and the display module 120 provides a display image I₂. The light-combining module 130 is disposed in the transmission path L₁ of the display image I₁ and the transmission path L₂ of the display image I₂.

As shown in FIG. 1, the display image I₁ passes through the light-combining module 130 along the transmission path L₁, the display image I₂ is reflected by the light-combining module 130 along the transmission path L₂, and the transmission path L₁ and the transmission path L₂ after the light-combining module 130 have an identical direction. In other words, the display image I₁ transmitted along the transmission path L₁ can pass through the light-combining module 130 and the display image I₂ transmitted along the transmission path L₂ would be reflected by the light-combining module 130, wherein transmitted directions of the display image I₁ along the transmission path L₁ and the transmitted direction of the display image I₂ along the transmission path L₂ are both towards the view-scanning layer 140. In the exemplary embodiment, since the display image and the display image I₂ are sequentially provided to the view-scanning layer 140 by different display modules (i.e. display module 110 and display module 120) at different time, so that the exemplary embodiment can reduce the image cross-talk of the 3D display 100.

Referring to FIG. 1, the view-scanning layer 140 receives the display image I₁ transmitted along the transmission path L₁ and the display image I₂ transmitted along the transmission path L₂ and respectively projects a part of the display image I₁ and a part of the display image I₂ onto a view direction d₁ and a view direction d₂. In addition, the 3D display 100 of the exemplary embodiment further includes a display module 150 for providing a display image I₃. As shown in FIG. 1, the light-combining module 130 is further disposed on a transmission path L₃ of the display image I₃, wherein the display image I₃ transmitted along the transmission path L₃ is reflected by the light-combining module 130 to the view-scanning layer 140, and after the display image I₃ transmitted along the transmission path L₃ leaves from the light-combining module 130, the display image I₃ is transmitted along a direction identical with the direction of the two transmission path L₁ and the transmission path L₂. In other words, display image I₃ transmitted along the transmission path L₃ would be reflected by the light-combining module 130 to the view-scanning layer 140 and the transmitted direction thereof is towards the view-scanning layer 140 as well. In this way, the view-scanning layer 140 receives the display image I₃ transmitted along the transmission path L₃ and projects a part of the display image I₃ onto the view direction d₃.

In the exemplary embodiment, the display modules 110, 120 and 150 respectively further provide display images I₄, I₅ and I₆, while the display images I₄, I₅ and I₆ are respectively transmitted along the transmission paths L₁, L₂ and L₃ to the view-scanning layer 140. After that, the view-scanning layer 140 respectively projects parts of the display images I₄, I₅, I₆ onto the view directions d₄, d₅ and d₆.

As shown in FIG. 1, the display module 110 of the exemplary embodiment includes a backlight unit 112 and a light valve 114, wherein the light valve 114 is disposed on the backlight unit 112 and the backlight unit 112 provides a backlight which is, for example, a light emitting diode (LED) backlight, an organic light emitting diode (OLED) backlight or a cold cathode fluorescent lamp (CCFL) backlight. The light valve 114 controls the luminous flux received by the view-scanning layer 140 and is, for example, a liquid crystal panel (LC panel). The display module 120 of the exemplary embodiment includes a backlight unit 122 and a light valve 124, and the display module 150 includes a backlight unit 152 and a light valve 154. In general speaking, the display modules 110, 120 and 150 alternately and quickly provide display images I₁-I₁₂ (only twelve are schematically shown in FIG. 1), and the view-scanning layer 140 respectively receives the display images I₁-I₁₂ at different time. However, in another exemplary embodiment, the display modules 110, 120, and 150 may be, for example, LED display panels or OLED display panels without the backlight units 112, 122, and 152, respectively.

FIG. 2 is a localized enlarged diagram of the region A in the three-dimensional display 100 of FIG. 1. Referring to both FIGS. 1 and 2, the view-scanning layer 140 has a plurality of light refraction modulation regions B, and each of the light refraction modulation regions B includes a view-scanning unit 142.

As shown in FIG. 2, the view-scanning layer 140 further includes a first substrate 144 and a second substrate 146, wherein the first substrate 144 includes a lower substrate 144a and a common electrode 144b. The common electrode 144b is disposed on the lower substrate 144a and the view-scanning unit 142 is disposed on the common electrode 144b. The second substrate 146 includes an upper substrate 146a and a plurality of control electrodes 146b, wherein the control electrodes 146b are disposed on the upper substrate 146a and the upper substrate 146a is disposed on the view-scanning unit 142. In the exemplary embodiment, the material of the common electrode 144b and the control electrodes 146b is a transparent conductive material, e.g. indium tin oxide (ITO) or indium zinc oxide (IZO).

It should be noted that, the view-scanning unit 142 would change a ongoing direction of an incident light with a variation of an external electric field so as to respectively project the partial display image I₁ and the partial display image I₂ onto the view direction d₁ and the view direction d₂, wherein each the view direction corresponds to the ongoing direction of the light. In general, the view-scanning unit 142 respectively projects parts of the display images I₁-I₁₂ onto different view directions d₁-d₅ (only schematically show six are shown in FIGS. 1 and 2). In the exemplary embodiment, the view-scanning layer 140 is composed of, for example, liquid crystal molecules (LC molecules) 142a, and the light refraction modulation regions B include a plurality of LC molecules 142a (one is schematically shown in FIG. 2).

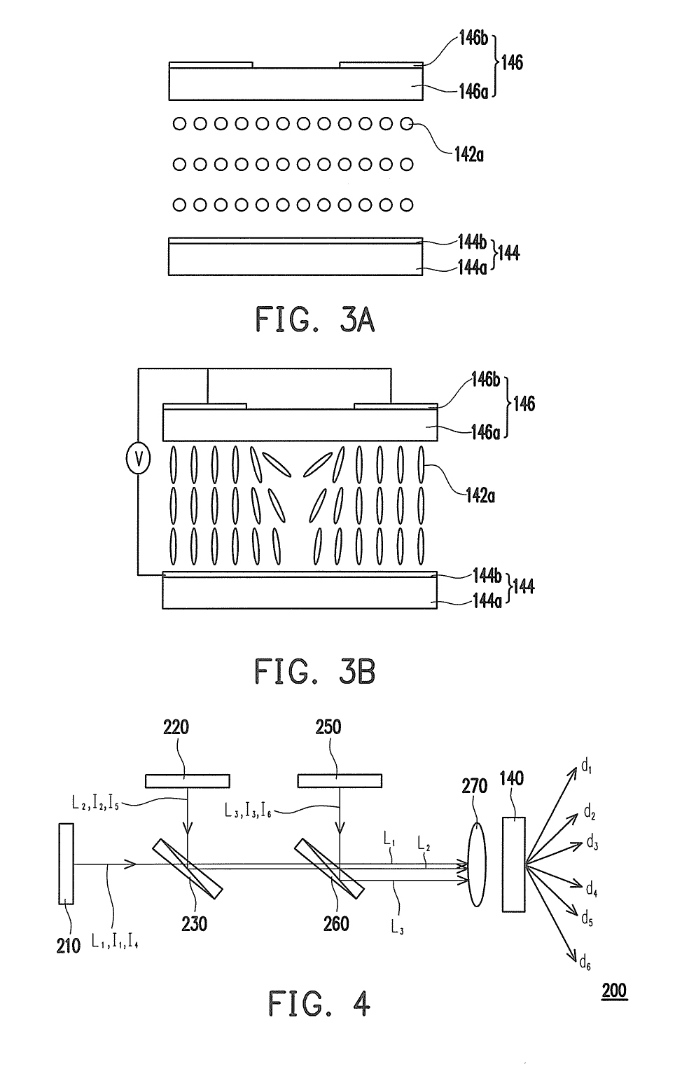

FIG. 3A is a schematic diagram showing an arrangement of the LC molecules 142a without applying an external electric field of the region C of FIG. 2, and FIG. 3B is a schematic diagram showing an arrangement of the LC molecules 142a after applying an external electric field on the LC molecules 142a of the region C of FIG. 2. Referring to FIGS. 2 and 3A, when no external voltage is applied on the common electrode 144b and the control electrodes 146b, the LC molecules 142a are not affected by the external electric field so that the LC molecules 142a are arranged along the same direction (i.e., along the direction perpendicular to the paper). In addition, the LC molecules are characterized by birefringence and the effective refractive index thereof can be expressed by n_{eff}(θ)=\sqrt{nₒ(θ)+nₑ(θ)²}, where nₒ is a refractive index along the short-axis of LC molecules and nₑ is a refractive index along the long-axis of LC molecules. Hence, for the light incident to the LC molecules 142a in the same direction and at different positions, the effective refractive indexes of the LC molecules 142a are all the same. Thus, the incident light at the same direction has the same refraction direction after passing through the LC molecules 142a.

Referring to FIG. 3B, when a voltage V is applied on the common electrode 144b and the control electrodes 146b, the LC molecules 142a at different positions have different tilt statuses corresponding to the electric field amount at the corresponding positions. Hence, for the light incident to the LC molecules 142a in the same direction and at different positions, the effective refractive indexes of the LC molecules 142a are different, which makes the incident light in the same direction be refracted to different directions when passing through the LC molecules 142a at different positions.

According to the above-mentioned principle, when the external electric field is continuously varied with time, for the incident light in the same direction, the equivalent refractive indexes of the LC molecules 142a are continuously varied, so that the parts of the display images I₁-I₁₂ from the display modules 110, 120 and 150 would be projected by the LC molecules 142a at different time onto a plurality of view directions d₁-d₆ as shown in FIG. 1 (i.e., the so-called time-multiplexed concept). It should be noted that, in the exemplary embodiment, the continuous variation of the equivalent refractive indexes of the LC molecules 142a is deemed equivalent to the continuous movement of the view-scanning unit 142 as shown in FIG. 2, and the function of the view-scanning unit 142 is similar to that of a gradient-index lens (GRIN lens).

Referring to FIGS. 1 and 2, given that the display modules 110, 120 and 150 respectively provide the display images I₁-I₁₂ at image frame periods t₁-t₁₂, then, the view-scanning unit 142 is regarded as being located at a position P₁ at the image frame periods t₁-t₆, and view-scanning unit 142 respectively refracts parts of display images I₁-I₆ onto the view directions d₁-d₆ at the image frame periods t₁-t₆. In more details, the display module 110 respectively provides the display images I₁ and I₄ at the image frame periods t₁ and t₄ to the view-scanning layer 140. Then, the view-scanning layer 140 respectively projects the partial display images I₁ and the partial display images I₄ onto the view directions d₁ and d₄. Similarly, the display module 120 respectively provides the display images I₂ and I₅ at the image frame periods t₂ and t₅ and the view-scanning layer 140 respectively projects the partial display images I₂ and the partial display images I₅ onto the view directions d₂ and d₅. And analogically for the rest, the display module 150 respectively provides the display images I₃ and I₆ at the image frame periods t₃ and t₆ and the view-scanning layer 140 respectively projects the partial display images I₃ and the partial display images I₆ onto the view directions d₃ and d₆.

On the other hand, at the image frame periods t₇-t₁₂, the view-scanning unit 142 can be regarded as being located at a position P₂, and the view-scanning unit 142 respectively projects parts of display images I₇-I₁₂ onto the view directions d₁-d₆ at the image frame periods t₇-t₁₂. That is to say, the view-scanning unit 142 formed by the LC molecules 142a is equivalent to a moveable switching LC lens which continuously moves back and forth within the light refraction modulation regions B. The display images I₁ and I₇ are substantially the same display images, whereas the view-scanning unit 142 would project different parts of the display images I₁ (display images I₇) at different positions (e.g. at the position P₁ and the position P₂). Thus, the movement of the view-scanning unit 142 from the position P₁ to the position P₂ should be completed within a frame period, such that the viewer is able to perceive the complete 3D display image. For example, if the frame frequency is 60 Hz (i.e., the different display images I₁-I₆ must be finished within 16.67 ms). The operation frequency of each of the light valves 114, 124 and 154 is 120 Hz, and therefore the duration of turning on the light valve is about 16.67 ms/6=2.8 ms.

In the exemplary embodiment, the view-scanning unit 142 located at the position P₁ and the position P₂ respectively provide half of each of the display images I₁-I₆ (or display images I₇-I₁₂). Thus, the 3D-display 100 employs a time multiplexed method to display the entire 3D image, which is different from the conventional 3D display displaying the 3D image by spatially partitioning the display image into an image received by the left eye and an image received by the right eye. In addition, the 3D-display 100 does not have image flickers occurring in the conventional time-multiplexed display.

It should be noted that, the view-scanning unit 142 of the exemplary embodiment is equivalent to a lens. However, the view-scanning unit 142 may be equivalent to any component which changes the ongoing direction of the light, e.g. a prism or a LC grating that changes the ongoing direction of the light by changing the relative positions of the common electrode 144b and the control electrodes 146b. In addition, even though the view-scanning unit 142 of the exemplary embodiment is composed of the LC molecules 142a, the view-scanning unit 142 can also be composed of electrowetting fluid in other embodiments.

In addition, the number of the view directions d₁-d₆ in the exemplary embodiment is schematically six. However, in other exemplary embodiment, the three-dimensional display can provide other numbers of view directions, for example, 32 different view directions, wherein the 32 view directions cyclically repeat every 32 image frame periods, and the duration from the first image frame period to the 32-th image frame period is shorter than a range of time of human visual persistence.

Since the 3D display 100 of the exemplary embodiment has three display modules (i.e. the display modules 110, 120 and 150) so that the updating speed of the display images I₁-I₁₂ can be increased. In more details, if at the image frame period t₁, the display images I₁ is provided by the display module 110, then the display images I₂ at the image frame period t₂ and the display images I₃ at the image frame period t₃ are respectively provided by the display module 120 and the display module 150. In this way, the display module 110 is able to prepare the display images I₄ for the next image frame period t₄ at the same time when the display module 120 provides the display images I₂ or when the display module 150 provides the display images I₃, which means the display images I₁-I₁₂ of the exemplary embodiment are alternately provided by the display modules 110, 120 and 150. As a result, not only the image updating speed of the display images I₁-I₁₂ is increased, but also the image cross-talk between the display images (e.g., between the display images I₁ and I₄) is effectively reduced.

In the following exemplary embodiments of figs, the same or similar notations represent the same or similar components for simplicity.

### The Second Exemplary Embodiment

FIG. 4 is a schematic diagram illustrating a 3D display 200 according to the second exemplary embodiment of the present disclosure. Referring to FIG. 4, a 3D display 200 includes two display modules 210 and 220, a light-combining module 230 and a view-scanning layer 140. The display module 210 provides a display image I₁ (shown in FIG. 1), the display module 220 provides a display image I₂ (shown in FIG. 1) and the light-combining module 230 is disposed on the transmission path L₁ of the display image Iₜ and the transmission path L₂ of the display image I₂.

As shown in FIG. 4, the display image I₁ passes through the light-combining module 230 along the transmission path L₁, the display image I₂ along the transmission path L₂ is reflected by the light-combining module 230, and the transmission path L₁ and the transmission path L₂ after the light-combining module 230 have the identical direction. In other words, the display image I₁ transmitted along the transmission path L₁ can pass through the light-combining module 230 and the display image I₂ transmitted along the transmission path L₂ would be reflected by the light-combining module 230, wherein both the transmitted direction of the transmission path L₁ and the transmitted direction of the transmission path L₂ are towards the view-scanning layer 140. In the exemplary embodiment, since the display image I₁ and the display image I₂ are sequentially provided to the view-scanning layer 140 by different display modules (display module 210 and display module 220) at different time, the exemplary embodiment can reduce the image cross-talk of the 3D display 200. As shown in FIG. 4, the 3D display 200 further includes a lens 270, which converges the incident light beam. The lens 270 is disposed between the display module 210 and the view-scanning layer 140 and located in the transmission path L₁ and the transmission path L₂.

The 3D display 200 of the exemplary embodiment further includes a display module 250 and a light-combining module 260, wherein the display module 250 provides the display image I₃ (shown by FIG. 1). Referring to FIG. 4, the light-combining module 260 is disposed between the light-combining module 230 and the view-scanning layer 140 and located in the transmission path L₃ of the display images I₃. The display image I₃ along the transmission path L₃ is reflected by the light-combining module 260 to the view-scanning layer 140 and the transmission path L₃ has a direction identical to the direction of the two transmission path L₁ and the transmission path L₃ after passing through the light-combining module 260. In other words, the display image I₃ transmitted along the transmission path L₃ would be reflected by the light-combining module 260 to the view-scanning layer 140 and the direction of the transmission path L₃ is towards the view-scanning layer 140 as well. In this way, the view-scanning layer 140 receives the display image I₃ transmitted along the transmission path L₃ and projects a part of the display image I₃ onto the view direction d₃.

Same as the first exemplary embodiment, the display modules 210, 220 and 250 in the exemplary embodiment respectively provide the display image I₄ transmitted along the transmission path L₁ (shown in FIG. 1), the display image I₅ transmitted along the transmission path L₂ (shown in FIG. 1) and the display image I₆ transmitted along the transmission path L₃ (shown in FIG. 1). After that, the view-scanning layer 140 respectively projects parts of the display images I₄, I₅, I₆ onto the view directions d₄, d₅ and d₆. The operation principle of the view-scanning layer 140 of the exemplary embodiment can refer to the first exemplary embodiment, which is omitted hereinafter.

In the exemplary embodiment, the display modules 210, 220 and 250 are, for example, an LED display panel or an OLED display panel. In the exemplary embodiment, the display modules 210, 220 and 250 produce different gray levels by changing the current for driving the LEDs. Since the 3D display 200 of the exemplary embodiment has three display modules (210, 220 and 250), the image updating speed of the display images I₁-I₁₂ can be increased. If the frame frequency is 60 Hz (i.e., the different display images I₁-I₆ are finished within 16.67 ms), the operation frequency of each of the display modules 210, 220 and 250 is 120 Hz.

### The Third Exemplary Embodiment

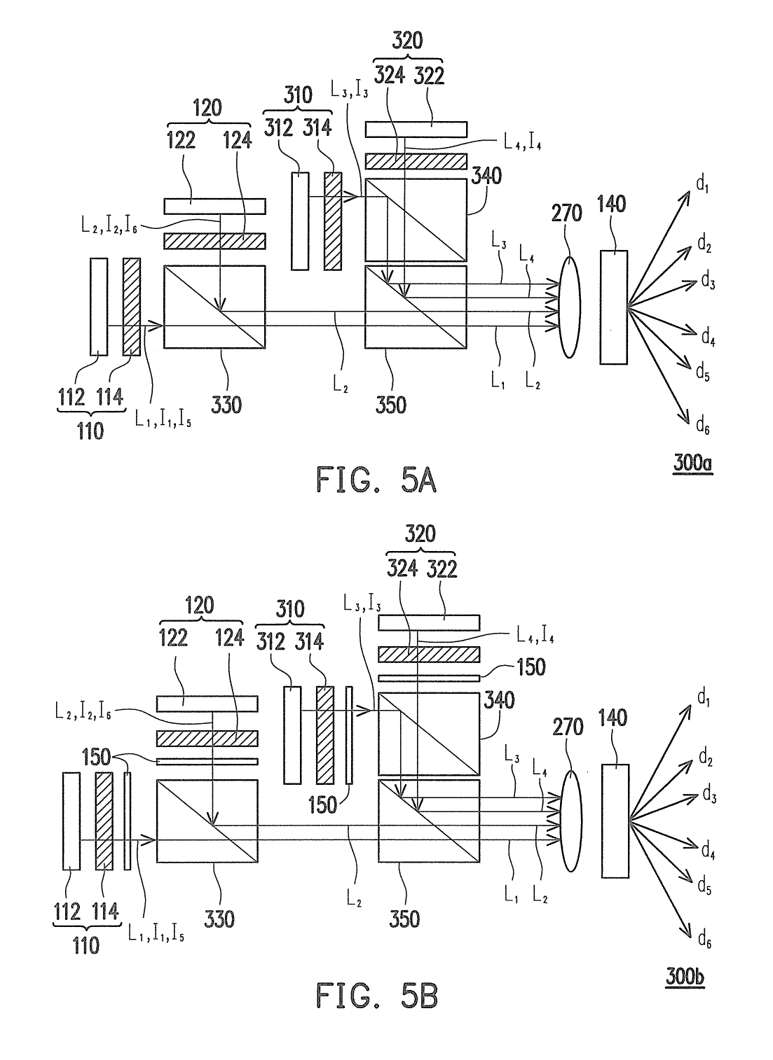

FIG. 5A is a diagram illustrating a 3D display 300a according to the third exemplary embodiment of the present disclosure. Referring to FIG. 5A, a 3D display 300a includes a view-scanning layer 140, a lens 270, four display modules 110, 120, 310 and 320, and three light-combining modules 330, 340 and 350. The display module 110 and the display module 120 respectively provide the display image I₁ (shown in FIG. 1) and the display image I₂ (shown in FIG. 1). The light-combining module 330 is disposed in the transmission path L₁ of the display image I₁ and the transmission path L₂ of the display image I₂. Similarly to the first exemplary embodiment, the display module 310 of the exemplary embodiment includes a backlight unit 312 and a light valve 314, and the display module 320 of the exemplary embodiment includes a backlight unit 322 and a light valve 324, wherein the light valves 314 and 324 are, for example, an LCD panel for controlling the luminous flux. However, in another exemplary embodiment, the display modules 110, 120, 310, and 320 may be, for example, LED display panels or OLED display panels without the backlight units 112, 122, 312, and 322, respectively.

As shown in FIG. 5A, the display image I₁ passes through the light-combining module 330 along the transmission path L₁, and the display image I₂ along the transmission path L₂ is reflected by the light-combining module 330, wherein the transmission path L₁ and the transmission path L₂ after the light-combining module 330 have the identical direction. In other words, the display image I₁ transmitted along the transmission path L₁ can pass through the light-combining module 330 and the display image I₂ transmitted along the transmission path L₂ would be reflected by the light-combining module 330, wherein both the transmitted direction of the transmission path L₁ and the transmitted direction of the transmission path L₂ are towards the view-scanning layer 140.

As shown in FIG. 5A, the light-combining module 340 is disposed between the display module 310 and the view-scanning layer 140 and between the display module 320 and the view-scanning layer 140. In addition, the light-combining module 340 is located on the transmission path L₃ of the display images I₃ (shown in FIG. 1) and the transmission path L₄ of the display images I₄ (shown in FIG. 1). The display images I₃ along the transmission path L₃ is reflected by the light-combining module 340 to the view-scanning layer 140, and the display images I₄ along the transmission path L₄ passes through the light-combining module 340, wherein the two transmission path L₃ and the transmission path L₄ have the identical direction after the light-combining module 340.

The light-combining module 350 is disposed between the light-combining module 330 and the view-scanning layer 140 and between the light-combining module 340 and the view-scanning layer 140. As shown in FIG. 5A, the transmission paths L₁ and L₂ pass through the light-combining module 350 and then extend to the view-scanning layer 140, while the transmission paths L₃ and L₄ are reflected by the light-combining module 350 to the view-scanning layer 140. As shown in FIG. 5A, the transmission paths L₃ and L₄ after the light-combining module 350 have the identical direction. After that, the view-scanning layer 140 respectively projects a part of the display image I₁ transmitted along the transmission paths L₁, a part of the display image I₂ transmitted along the transmission paths L₂, a part of the display image I₃ transmitted along the transmission paths L₃ and a part of the display image I₄ transmitted along the transmission paths L₄ onto the view directions d₁-d₄.

On the other hand, in the exemplary embodiment, the display module 110 and the display module 120 respectively provide the display image I₅ and the display image I₆. The display image I₅ and the display image I₆ are respectively transmitted along the transmission paths L₁ and L₂. Similarly, the view-scanning layer 140 projects parts of the display images I₅ and I₆ onto the view directions d₅ and d₆. The operation principle of the view-scanning layer 140 of the exemplary embodiment can refer to the first exemplary embodiment which is omitted hereinafter.

Since the 3D display 300a of the exemplary embodiment has four display modules 110, 120, 310 and 320, the image updating speed of the display images I₁-I₁₂ can be increased. In addition, due to the increased number of the light valves, under the situation of 60 Hz of the frame frequency (i.e. different display image I₁-I₆ need to be finished within 16.67 ms), the operation frequencies of the light valves 114 and 124 are roughly above 120 Hz, and the operation frequencies of the light valves 314 and 324 are roughly above 60 Hz.

In another exemplary embodiment, as shown in FIG. 5B, the display module 110 further includes a switch light valve 150. The switch light valve 150 is disposed in the transmission path L₁ of the display images I₁ to control whether the display image I₁ passes through or not, and the switch light valve 150 is, for example, a shutter. The remaining display modules of the exemplary embodiment also include the switch light valves 150 disposed before the light valves.

Taking the display module 110 as an example, the switch light valve 150 controls the pass of the display image I₁, for example. In more details, when the display module 110 forms the display image I₁, the switch light valve 150 is suitable to be turned on to allow the display image I₁ to be transmitted to the view-scanning layer 140. Contrarily, when the display module 120 provides the display image I₂ to the view-scanning layer 140, the switch light valve 150 of the display module 110 is turned off to block the display image I₁ to pass through. Meanwhile, the switch light valve 150 of the display module 120 is also turned on to allow the display image I₂ transmitted to the view-scanning layer 140.

It should be noted that, in the exemplary embodiment of FIG. 5B, in order to display the display image I₁ at the next time, the display module 110 is able to transmit the display image I₁ to the view-scanning layer 140 again by just turning on the switch light valve 150 of the display module 110. Since the display image I₁ has been formed already which is just waiting for turning on the switch light valve 150 at the time, the frame updating speed of the 3D display 300b is advanced. In other words, the switch light valves 150 of the exemplary embodiment are alternately turned on quickly to transmit the available display images I₁-I₆ to the view-scanning layer 140.

### The Fourth Exemplary Embodiment

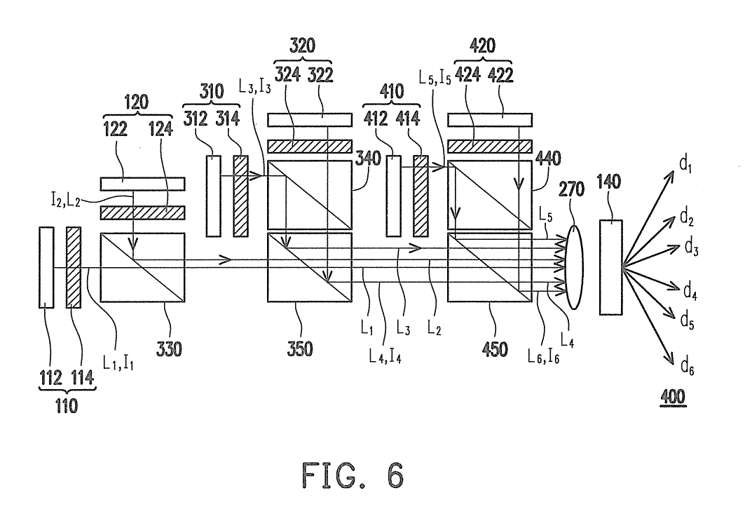

FIG. 6 is a diagram illustrating a 3D display 400 according to the forth exemplary embodiment of the present disclosure. The 3D display 400 of the exemplary embodiment is similar to the 3D display 300a of the third exemplary embodiment except that the 3D display 400 further includes two display modules 410 and 420 and two light-combining modules 440 and 450. Similarly, the display module 410 also includes a backlight unit 412 and a light valve 414 and the display module 420 also includes a backlight unit 422 and a light valve 424. The light valve 414 and 424 are respectively, e.g., an LCD panel, and the backlight units 412 and 422 are, e.g., a LED backlight, an OLED backlight, or a CCFL backlight. However, in another exemplary embodiment, the display modules 110, 120, 310, 320, 410, and 420 may be, for example, LED display panels or OLED display panels without the backlight units 112, 122, 312, 322, 412 and 422, respectively.

It should be noted that the display images I₅ and I₆ of the exemplary embodiment are respectively provided by the display modules 410 and 420. In other words, the display images I₁-I₆ of the exemplary embodiment are provided by the six display modules 110, 120, 310, 320, 410 and 420.

As shown in FIG. 6, the light-combining module 440 is disposed between the display module 410 and the view-scanning layer 140 and between the display module 420 and the view-scanning layer 140. The light-combining module 440 is located in the transmission path L₅ of the display images I₅ (shown in FIG. 1) and the transmission path L₆ of the display images I₆ (shown in FIG. 1). The display images I₅ of the transmission path L₅ is reflected by the light-combining module 440 to the view-scanning layer 140 and the display images I₆ of the transmission path L₆ passes through the light-combining module 440, wherein the transmission path L₅ and the transmission path L₆ after the light-combining module 440 have the identical direction.

On the other hand, the light-combining module 450 is disposed between the light-combining module 350 and the view-scanning layer 140 and between the light-combining module 440 and the view-scanning layer 140. As shown in FIG. 6, the transmission paths L₁-L₄ pass through the light-combining module 450 and then extend to the view-scanning layer 140, while the transmission paths L₅ and L₆ are reflected by the light-combining module 450 to the view-scanning layer 140. In other words, the transmission paths L₁-L₆ after the light-combining module 450 have the identical direction. After that, the view-scanning layer 140 respectively projects parts of the display images I₁-I₆ transmitted along the transmission paths L₁-L₆ onto the view directions d₁-d₆. The operation principle of the view-scanning layer 140 of the exemplary embodiment can refer to the first exemplary embodiment which is omitted hereinafter.

Since the 3D display 400 of the exemplary embodiment has six display modules 110, 120, 310, 320, 410 and 420, the image updating speed of the display images I₁-I₁₂ (shown in FIG. 1) can be advanced. In addition, with the six display modules of the exemplary embodiment, under the situation of 60 Hz of frame frequency (i.e., the different display images I₁-I₆ need to be finished in 16.67 ms), the operation frequency of each of the light valves 114, 124, 314, 324, 414 and 424 is roughly about 60 Hz.

### The Fifth Exemplary Embodiment

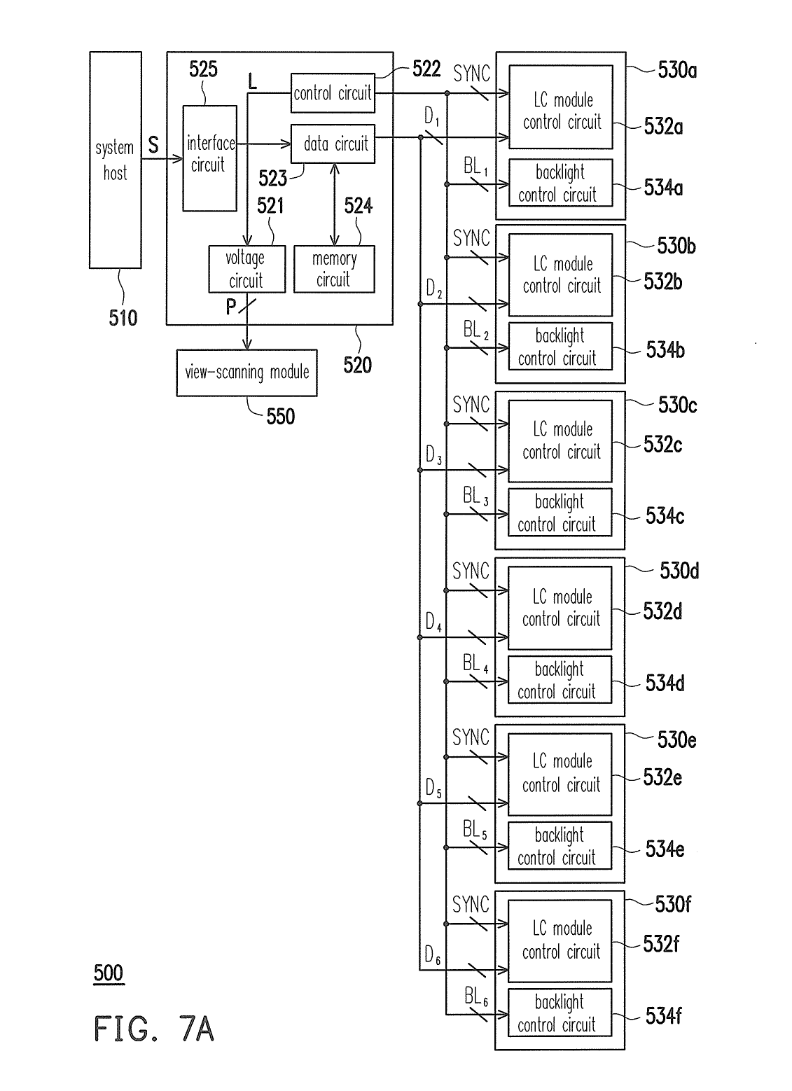

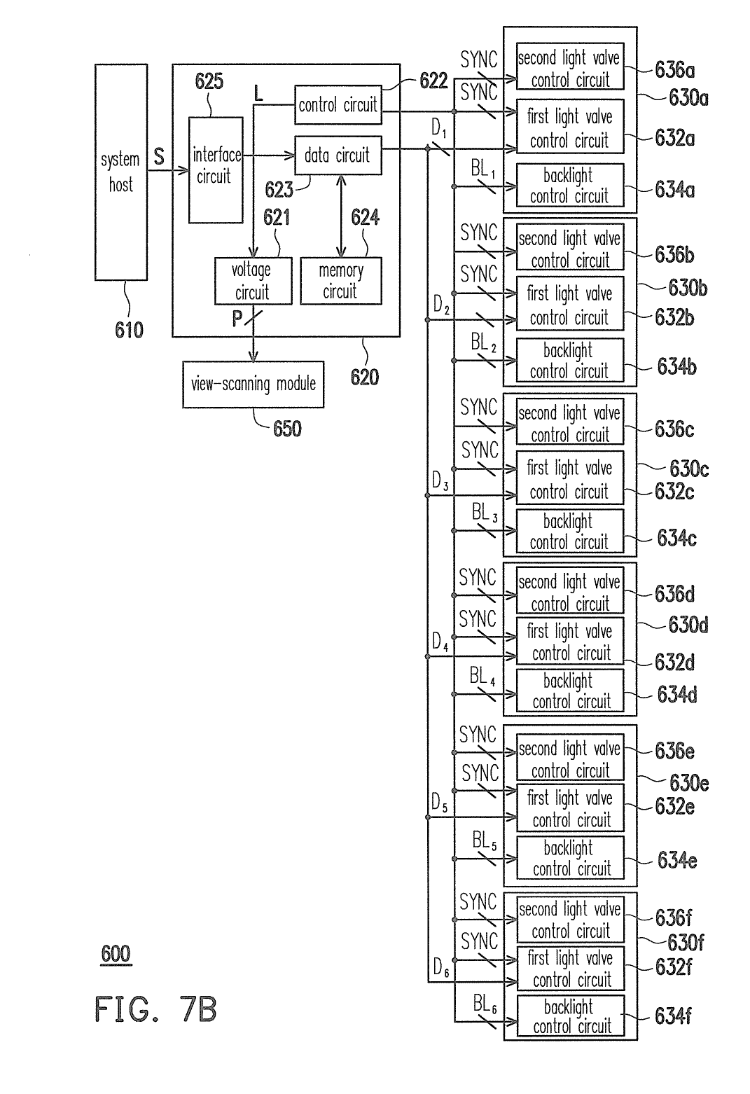

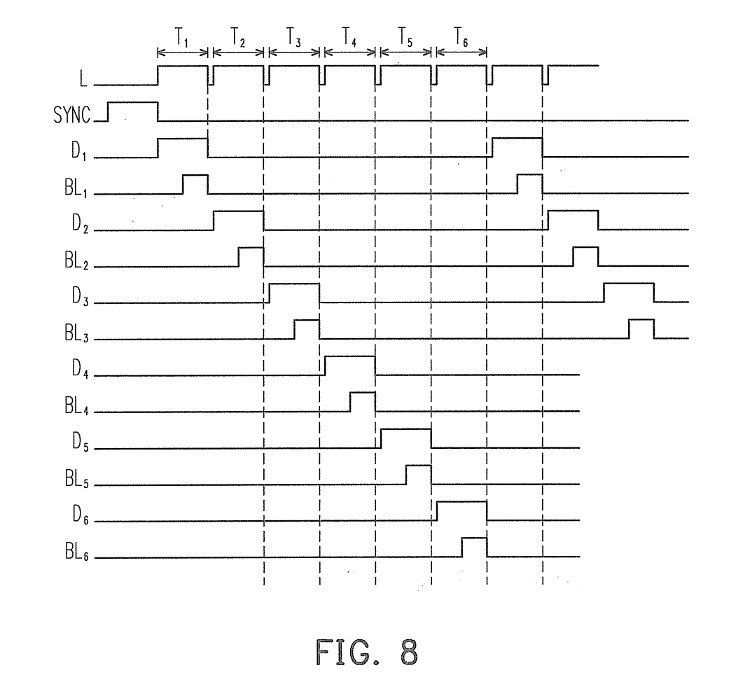

FIG. 7A is a block diagram of a 3D display system according to the fifth exemplary embodiment of the present disclosure and FIG. 8 is a timing diagram of the 3D display system of FIG. 7A. As shown in FIG. 7A, a 3D display system 500 includes a processing unit 520, a plurality of display modules 530a-530f and a view-scanning module 550. The processing unit 520 is suitable to output a plurality of video data D₁-D₆, a plurality of control signals BL₁-BL₆ and a scan signal P. The display modules 530a-530f are coupled to the processing unit 520 and respectively receive the video data D₁-D₆ and the control signals BL₁-BL₆, wherein the control signals BL₁-BL₆ are, for example, backlight control signals.

Referring to FIGS. 6 and 7A, in the exemplary embodiment, each of the display modules 530a-530f provides a display image (for example, one of the display images I₁-I₆ of the first exemplary embodiment) according to the corresponding video data D₁-D₆ and control signals BL₁-BL₆. The view-scanning module 550 is coupled to the processing unit 520 and receives the scan signal P and projects parts of the display images (for example, the display image I₁) passing through the view-scanning module 550 onto one of a plurality of view directions (for example, view direction d₁ in FIG. 1) according to the scan signal P.

In addition, the processing unit 520 of the exemplary embodiment can be, for example, field programmable gate array (FPGA) or application specific integrated circuit (ASIC). The processing unit 520 includes a voltage circuit 521, a control circuit 522, a data circuit 523, a memory circuit 524 and an interface circuit 525, wherein the interface circuit 525 receives, for example, a video signal S from a system host 510. On the other hand, each display module (for example, display module 530a) includes a light valve control circuit (for example, LC module control circuit 532a) and a backlight control circuit (for example, backlight control circuit 534a). In more details, the LC module control circuit 532a receives a simultaneous signal SYNC from the control circuit 522 and the corresponding video data D₁ of the data circuit 523 and adjusts the luminous flux of the light passing through the light valve (for example, the light valve 114 in FIG. 6) according to the video data D₁. That is to say, the LC module control circuit 532a is used to control the gray level of the display frames.

The backlight control circuit 534a receives the corresponding control signal BL₁ from the control circuit 522. The control signal BL₁ decides whether turns on or turns off of the backlight unit (for example, the backlight unit 112 in FIG. 6), wherein when the backlight unit 112 is turned on, the display module 530a provides a display image (for example, the display image I₁) to the view-scanning module 550. The voltage circuit 521 generates the scan signal P according to a voltage control signal L from the control circuit 522. The scan signal P is, for example, a control voltage for controlling the distribution of the electric field of the view-scanning module 550 so as to project the display image I₁ onto the view direction d₁ (shown in FIG. 6).

Referring to FIGS. 6, 7A, 7B and 8, in the exemplary embodiment, in association with the simultaneous signal SYNC, the processing unit 520 respectively transmits the video data D₁-D₆ and the control signals BL₁-BL₆ in sequence. In more details, during the frame time T₁, the LC module control circuit 532a receives the video data D₁ from the processing unit 520 and adjusts the luminous flux of the light passing through the light valve 114 (i.e. adjusting the gray level of the display image) according to the video data D₁. Meanwhile, the view-scanning module 550 receives the scan signal P from the processing unit 520 so as to make the view-scanning unit 142 of FIG. 2 finish the moving action. After that, the backlight control circuit 534a is able to turn on the backlight unit 112 according to the control signal BL₁ from the processing unit 520. After the light valve 114 finishes adjusting the luminous flux, the backlight unit 112 can be turned on. After the backlight unit 112 is turned on, the display module 532a provides a display image (for example, the display image I₁) to the view-scanning module 550. Finally, the view-scanning module 550 projects a part of the display image I₁ onto the view direction d₁.

During the frame time T₂, the LC module control circuit 532b receives the video data D₂ from the processing unit 520 and adjusts the luminous flux of the light passing through the light valve 124 according to the video data D₂. Meanwhile, the view-scanning module 550 receives the scan signal P from the processing unit 520 so as to make the view-scanning unit 142 of FIG. 2 finish the moving action. After that, the backlight control circuit 534b is able to turn on the backlight unit 122 according to the control signal BL₂ from the processing unit 520. After the light valve 124 finishes adjusting the luminous flux, the backlight unit 122 can be turned on. After the backlight unit 122 is turned on, the display module 532b provides a display image (for example, the display image I₂) to the view-scanning module 550. Finally, the view-scanning module 550 projects a part of the display image I₂ onto the view direction d₂. The operations of the rest display modules 530c-530f can refer the above-mentioned display modules 530a and 530b, which is omitted hereinafter.

It should be noted that, in other exemplary embodiments, the video data D₁-D₆ are not necessary to be send out simultaneously, i.e., the video data D₂ can be transmitted during the time when the video data D₁ is transmitted. Since the display images I₁-I₆ are sequentially provided at different time to the view-scanning module 550 from the different display modules 530a-530f, the image cross-talk can be reduced. The number of the display modules can be designed by a designer, and the present disclosure is not limited thereto.

For example, when the number of the 3D display 100 (FIG. 1) or that of the 3D display 200 (FIG. 4) is reduced from three to one (for example, only the display module 110 or display module 210 is remained), the number of the display modules in FIG. 7 is correspondingly reduced from six to one (for example, only the display module 530a is remained). In other words, the display images I₁-I₆ are provided to the view-scanning module 550 by, for example, the display module 530a at different time. Under the situation, the display modules of FIG. 7A are not necessary to be a plurality of display modules and the display module is, for example, a LED display panel or a LCD panel. In addition, when the circuit of FIG. 7A is applied to FIG. 4 and the display modules 210, 220 and 250 of FIG. 4 are an LED display panel, the light valve control circuit of FIG. 7A (LC module control circuits 532a-532f) can be omitted. In other words, at the time, the display module can change the gray level of the display frames by, for example, controlling the current.

### The Sixth Exemplary Embodiment

FIG. 7B is a block diagram of a 3D display system according to the sixth exemplary embodiment of the present disclosure. Referring to FIG. 7B, a 3D display system 600 includes a processing unit 620, a plurality of display modules 630a-630f and a view-scanning module 650. The processing unit 620 is suitable to output a plurality of video data D₁-D₆, a plurality of control signals BL₁-BL₆ and a scan signal P. The display modules 630a-630f are coupled to the processing unit 620 and respectively receive the video data D₁-D₆ and the control signals BL₁-BL₆, wherein the control signals BL₁-BL₆ are, for example, backlight control signals.

In the exemplary embodiment, each display module includes a first light valve control circuit, a backlight control circuit and a second light valve control circuit. As shown in FIG. 7B, the display module 630a includes a first light valve control circuit 632a, a backlight control circuit 634a and a second light valve control circuit 636a. The first light valve control circuit 632a receives the corresponding video data D₁ and adjusts the luminous flux of the light passing through the first light valve according to the video data D₁. The first light valve is, for example, the light valve 114 of FIG. 6 and the first light valve is, for example, a LC module. At the time, the first light valve control circuit 632a is, for example, a LC module control circuit. In this way, by using the first light valve control circuit 632a to adjust the first light valve, the display module 630a is able to control the gray level of the display frames.

The backlight control circuit 634a receives the corresponding control signal BL₁ and turns on a backlight unit (for example, the backlight unit 122 in FIG. 6) according to the control signal BL₁ so as to form display images (for example, the display image I₁). Next, the second light valve control circuit 636a makes the display image (for example, the display image I₁) pass through a second light valve (for example, the switch light valve 150 in FIG. 5B) according to a simultaneous signal SYNC so as to further provide the display image I₁ to the view-scanning module 650. In the exemplary embodiment, the second light valve control circuit 636a is, for example, a switch light valve control circuit. The difference between the first light valve control circuit 632a and the second light valve control circuit 636a is that the first light valve control circuit 632a controls the gray level of the display frames, while the second light valve control circuit 636a controls whether the display image can be transmitted to the view-scanning module or not. The second light valve is, for example, a LC module able to block the light.

In more details, when the 3D display system 600 needs to display the display image I₁, the control circuit 636a would control the second light valve (for example, the switch light valve 150 in FIG. 5B) to be turned on, so that the display image I₁ can be transmitted to the view-scanning module 650. Contrarily, when the 3D display system 600 needs to display the display image I₂, the second light valve control circuit 636a would control the second light valve to be turned off, so that the display image I₁ is unable to be transmitted to the view-scanning module 650.

The second light valve control circuit 636b of the display module 630b controls the corresponding second light valve to be turned on, so that the display image I₂ can be transmitted to the view-scanning module 650. That is, during displaying the display image I₂, the display image I₁ is also simultaneously formed, but the display image I₁ is blocked by the second light valve. In this way, since the display image I₁ has formed already, at the next time when the display image I₁ is need to be displayed, the display image I₁ can be immediately displayed by just turning on the second light valve. Thus, the frame updating speed of the 3D display system 600 can be speeded up.

Since the functions of the display modules 630a-630f are the same, the operations of the remaining display modules 630b-630f can refer to the display module 630a, and the description thereof is omitted hereinafter. In the 3D display system 600, the system host 610 and the voltage circuit 621, control circuit 622, data circuit 623, memory circuit 624 and interface circuit 625 of the processing unit 620 can be refer to the 3D display system 500 of FIG. 7A, and the description thereof are also omitted hereinafter

In summary, the 3D display and the 3D display system of the exemplary embodiments of the disclosure respectively adopt a view-scanning layer and a view-scanning module with high response. Therefore, the time-multiplexed approach can be used and the display images can be continuously projected onto different directions at different time so as to realize wide view angles. In addition, since different display images are respectively provided in sequence by a plurality of display modules alternately, the display images can be formed quickly and the image cross-talk between images is reduced in the 3D display of the exemplary embodiments of the disclosure.

It will be apparent to those skilled in the art that the various modifications and variations can be made to the structure of the disclosed embodiments without departing from the scope or spirit of the disclosure. In view of the forgoing, it is intended that the disclosure covers modifications and variations of this disclosure provided they fall within the scope of the following claims and their equivalents.

What is claimed is:

1. A three-dimensional display, comprising:
a first display module, providing a first display image;
a second display module, providing a second display image;
a first light-combining module, disposed in a first transmission path of the first display image and a second transmission path of the second display image, wherein the first transmission path and the second transmission path after the first light-combining module have an identical direction; and
a view-scanning layer, receiving the first display image transmitted along the first transmission path and the second display image transmitted along the second transmission path and respectively projecting a part of the first display image and a part of the second display image onto a first view direction and a second view direction.

2. The three-dimensional display as claimed in claim 1, wherein the first display image transmitted along the first transmission path passes through the first light-combining module and the second display image transmitted along the second transmission path is reflected by the first light-combining module.

3. The three-dimensional display as claimed in claim 1, further comprising a third display module to provide a third display image, wherein the first light-combining module is further disposed in a third transmission path of the third display image, the third display image transmitted along the third transmission path is reflected by the first light-combining module to the view-scanning layer and a direction of the third transmission path after the first light-combining module is identical to the direction of the first transmission path and the second transmission path after the first light-combining module, the view-scanning layer receives the third display image transmitted along the third transmission path and projects a part of the third display image onto a third view direction.

4. The three-dimensional display as claimed in claim 3, wherein the first display module, the second display module and the third display module further respectively provide a fourth display image transmitted along the first transmission path, a fifth display image transmitted along the second transmission path and a sixth display image transmitted along the third transmission path, and the view-scanning layer respectively projects a part of the fourth display image, a part of the fifth display image and a part of the sixth display image onto a fourth view direction, a fifth view direction and a sixth view direction.

5. The three-dimensional display as claimed in claim 1, further comprising:
a third display module, providing a third display image; and
a second light-combining module, disposed between the first light-combining module and the view-scanning layer and located in a third transmission path of the third display image, wherein the third display image transmitted along the third transmission path is reflected by the second light-combining module to the view-scanning layer and a direction of the third transmission path after the second light-combining module is identical to the direction of the first transmission path and the second transmission path after the second light-combining module,
wherein the view-scanning layer receives the third display image transmitted along the third transmission path and projects a part of the third display image onto a third view direction.

6. The three-dimensional display as claimed in claim 5, wherein the first display module, the second display module and the third display module further respectively provide a fourth display image, a fifth display image and a sixth display image, and the view-scanning layer respectively projects a part of the fourth display image, a part of the fifth display image and a part of the sixth display image onto a fourth view direction, a fifth view direction and a sixth view direction.

7. The three-dimensional display as claimed in claim 1, further comprising:
a third display module, providing a third display image;
a fourth display module, providing a fourth display image;
a second light-combining module, disposed between the third display module and the view-scanning layer and between the fourth display module and the view-scanning layer and located in a third transmission path of the third display image and in a fourth transmission path of the fourth display image; and
a third light-combining module, disposed between the first light-combining module and the view-scanning layer and between the second light-combining module and the view-scanning layer and located in the first transmission path, the second transmission path, the third transmission path and the fourth transmission path,
wherein the view-scanning layer respectively projects a part of the third display image transmitted along the third transmission path and a part of the fourth display image transmitted along the fourth transmission path onto a third view direction and a fourth view direction.

8. The three-dimensional display as claimed in claim 7, wherein the third transmission path is reflected by the second light-combining module, the fourth transmission path passes through the second light-combining module, the first transmission path and the second transmission path pass through the third light-combining module, and the third transmission path and the fourth transmission path are reflected by the third light-combining module to the view-scanning layer.

9. The three-dimensional display as claimed in claim 7, wherein the first display module and the second display module further respectively provide a fifth display image transmitted along the first transmission path and a sixth display image transmitted along the second transmission path, and the view-scanning layer respectively projects a part of the fifth display image and a part of the sixth display image onto a fifth view direction and a sixth view direction.

10. The three-dimensional display as claimed in claim 8, further comprising:
a fifth display module, providing a fifth display image;
a sixth display module, providing a sixth display image;
a fourth light-combining module, disposed between the fifth display module and the view-scanning layer and between the sixth display module and the view-scanning layer and located in a fifth transmission path of the fifth display image and in a sixth transmission path of the sixth display image; and
a fifth light-combining module, disposed between the third light-combining module and the view-scanning layer and between the fourth light-combining module and the view-scanning layer and located in the first transmission path, the second transmission path, the third transmission path, the fourth transmission path and the sixth transmission path,
wherein the view-scanning layer respectively projects a part of the fifth display image transmitted along the fifth transmission path and a part of the sixth display image transmitted along the sixth transmission path onto a fifth view direction and a sixth view direction.

11. The three-dimensional display as claimed in claim 10, wherein the fifth transmission path is reflected by the fourth light-combining module, the sixth transmission path passes through the fourth light-combining module, the first transmission path, the second transmission path, the third transmission path and the fourth transmission path pass through the fifth light-combining module, and the fifth transmission path and the sixth transmission path are reflected by the fifth light-combining module to the view-scanning unit.

12. The three-dimensional display as claimed in claim 1, wherein the first display module comprises:
a backlight unit; and
a light valve, disposed on the backlight unit.

13. The three-dimensional display as claimed in claim 12, wherein the backlight unit comprises a light emitting diode backlight.

14. The three-dimensional display as claimed in claim 12, wherein the light valve comprises a liquid crystal panel.

15. The three-dimensional display as claimed in claim 1, wherein the first display module is a light emitting diode display panel.

16. The three-dimensional display as claimed in claim 1, wherein the first display module is an organic light emitting diode display panel.

17. The three-dimensional display as claimed in claim 1, wherein the view-scanning layer comprises a plurality of light refraction modulation regions, wherein each of the light refraction modulation regions comprises a view-scanning unit, the view-scanning unit changes a light ongoing direction with a variation of an external electric field so as to respectively project a part of the first display image and a part of the second display image onto the first view direction and the second view direction, wherein each view direction is corresponding to the light ongoing direction.

18. The three-dimensional display as claimed in claim 17, wherein the material of the view-scanning unit comprises liquid crystal molecules or electrowetting fluid.

19. The three-dimensional display as claimed in claim 17, wherein the view-scanning layer further comprises:
a first substrate, comprising a lower substrate and a common electrode, wherein the common electrode is disposed on the lower substrate and the view-scanning unit is disposed on the common electrode; and
a second substrate, comprising an upper substrate and a plurality of control electrodes, wherein the control electrodes are disposed on the upper substrate and the upper substrate is disposed on the view-scanning unit.

20. The three-dimensional display as claimed in claim 19, wherein a material of the common electrode and the control electrodes is a transparent conductive material.

21. The three-dimensional display as claimed in claim 19, wherein the common electrode and the control electrodes comprise indium tin oxide or indium zinc oxide.

22. The three-dimensional display as claimed in claim 1, further comprising a lens disposed between the first display module and the view-scanning layer and located in the first transmission path and the second transmission path.

23. The three-dimensional display as claimed in claim 1, wherein the first display module further comprises a switch light valve disposed in the first transmission path of the first display image to control whether the display image passes through or not.

24. A three-dimensional display system, comprising:
a processing unit, outputting a plurality of video data, a plurality of control signals and a scan signal;
at least one display module, coupled to the processing unit and respectively receiving the video data and the control signals, wherein the display module provides a display image according to the corresponding video data and control signal;
a view-scanning module, coupled to the processing unit and receiving the scan signal, wherein the view-scanning module projects a part of the display image passing through the view-scanning module onto one of a plurality of view directions according to the scan signal.

25. The three-dimensional display system as claimed in claim 24, wherein the display module comprises:
a light valve control circuit, receiving the corresponding video data and adjusting a luminous flux passing through a light valve according to the video data; and
a backlight control circuit, receiving the corresponding control signal, wherein the control signal determines whether a backlight unit turns on or turns off, when the backlight unit is turned on, the display module provides the display image to the view-scanning layer.

26. The three-dimensional display system as claimed in claim 25, wherein after the light valve finishes adjusting the luminous flux, the backlight unit is turned on.

27. The three-dimensional display system as claimed in claim 24, wherein the processing unit comprises a voltage circuit, the voltage circuit generates the scan signal according to a voltage control signal.

28. The three-dimensional display system as claimed in claim 27, wherein the scan signal is a control voltage.

29. The three-dimensional display system as claimed in claim 24, wherein the processing unit is a field programmable gate array or an application specific integrated circuit.

30. The three-dimensional display system as claimed in claim 24, wherein the at least one display module comprises a plurality of display modules.

31. The three-dimensional display system as claimed in claim 24, wherein the light valve control circuit is a liquid crystal module control circuit.

32. The three-dimensional display system as claimed in claim 24, wherein the display module comprises:
a first light valve control circuit, receiving the corresponding video data and adjusting a luminous flux passing through a first light valve according to the video data;
a backlight control circuit, receiving the corresponding control signal and turning on a backlight unit to form the display image according to the control signal; and
a second light valve control circuit, making the display image pass through a second light valve according to a simultaneous signal and further providing the display image to the view-scanning module.

33. The three-dimensional display system as claimed in claim 31, wherein the second light valve control circuit is a switch light valve control circuit.
